(19) United States
(12) Patent Application Publication
(10) Pub. No.: US 2008/0109800 A1
(43) Pub. Date: May 8, 2008

(54) Intelligent transmitter and software update method for same

(75) Inventors: Yuichiro Takahashi, Musashino-shi (JP); Toshimitsu Uemura, Musashino-shi (JP)

Correspondence Address: EDWARDS ANGELL PALMER & DODGE LLP, P.O. BOX 55874, BOSTON, MA, 02205, US

(73) Assignee: Yokogawa Electric Corporation, Tokyo (JP)

(21) Appl. No.: 11/975,160

(22) Filed: Oct. 17, 2007

(30) Foreign Application Priority Data
Oct. 18, 2006 (JP) 2006-283575

(51) Int. Cl. G06F 9/44

(52) U.S. Cl. 717/170

(57) ABSTRACT

When there is no agreement between the version of version update data stored in the master memory and the version information of software stored in a slave memory, the version update data is transferred to the slave side thereby rewriting the software stored in the slave memory. By updating the version update data at the master memory, the software for the slave can be updated without exchanging the hardware of the slave.

This application claims priority to Japanese Patent Application No. 2006-283575, filed Oct. 18, 2006, in the Japanese Patent Office. The priority application is incorporated by reference in its entirety.

### TECHNICAL FIELD

The present disclosure relates to a software update method for an intelligent transmitter to measure a process quantity, and more particularly to a software update method for a slave of an intelligent transmitter having a master and a slave.

### RELATED ART

FIG. 8 is an explanatory view showing an example of a related-art intelligent transmitter. The intelligent transmitter is structured with a master 73 and a slave 72, each of which has a CPU and an amplifier (circuit board) on which software is installed to control the CPU. The master 73 is of a bus-powered type connected to a superior system 76 through a two-wire loop 75 so that it can communicate data with the superior system 76 and acquire the power for driving the intelligent transmitter from the superior system 76. The slave 72 is of a bus-powered type connected to the master 73 through a cable 74 so that it can communicate data with the master 73 and acquire the power for driving the slave 72 from the master 73. The slave 72 is to measure the process quantity, such as pressure and temperature, of a process fluid by means of a sensor while the master 73 is to acquire the process variable through the cable 74, and display the process variable on a display 77, such as an LCD and send same to the superior system 76 through the two-wire loop 75.

The followings are included as the prior art documents related to the intelligent transmitter like the above.

[Patent Document 1] Japanese Patent Unexamined Publication No. 2002-215566

[Patent Document 2] Japanese Patent Unexamined Publication No. 2005-227920

Recently, functional improvement has been advanced for transmitters in the field of process automation. For the purpose of in-plant distributed control, there is a trend toward providing the transmitter with various functions of communication control, process control, etc. the DCS conventionally possessed. Along with this, version upgrade is frequently done to the transmitter-side software by means of bug repair and functional addition.

In the present situation, the version upgrade of transmitter software relies mainly on hardware exchange. Although there is a standardized technique of performing version upgrade the transmitter software (domain download) by way of a network, e.g. Foundation Fieldbus, no stipulations and embodiments are available as to version upgrade of a plurality of in-transmitter CPUs. For this reason, hardware exchange (e.g. body and amplifier) is needed in version upgrade of the slave 72 of a product having such a structure as in FIG. 8.

However, it is often cases to use such a product structured as in FIG. 8 in a situation that the measuring location lies at a site not easy for the operator to access (closed, narrow, high, dangerous or so) because of its feature. In such a case, by arranging the slave at the measuring location and the master in a place easy for the operator to access, measurement result can be confirmed on the master's display without the need for the operator to go to the measuring location.

Consequently, slave-side version upgrade (exchange operation) requires sufficient maintenance of safety, including plant shutdown and protective gear (heat-resistant suit, gas mask, safety catcher, etc), thus raising a problem that it is not easy to implement.

### SUMMARY

Exemplary embodiments of the present invention provide an intelligent transmitter having a master and a slave, whose software on the slave is subject to the version upgrade without exchanging the hardware, thereby making it possible to reduce the operator of risk and diminish the cost required for maintenance of safety and exchange operation.

According to one or more embodiments of the present invention, an intelligent transmitter comprising:

a master to which electric power is supplied from a superior system through a first communication line; and

a slave to which electric power is supplied from the master through a second communication line, the slave being to send a process variable as measured according to a software to the master through the second communication line,

Wherein the master includes a first memory for storing version upgrade data for the software, and

the slave includes a second memory for storing the software and a version of the software.

The master may compare version information about the software sent from the slave with version information of version upgrade data, and when there is no agreement in the version information, the slave may rewrite the software for the second memory on a basis of the version upgrade data sent from the master.

The master may receive the version upgrade data from the superior system through the first communication line.

The master may output information about a progress of version update to a display.

After the version upgrade, the master may collate storage content of the software in the second memory with the version upgrade data.

The software may be repaired when there is no agreement in a collation result.

The master and the slave may be connected by a connector and accommodated in a same transmitter case.

The slave may be in plurality and the second communication line may be in plurality so that the plurality of slaves can be connected to the master, and the version upgrade data may have identification information on a slave-by-slave basis and the software for the slaves may be updated according to the identification information.

Further, according to one or more embodiments of the present invention, a software update method for an intelligent transmitter having a master to which electric power is supplied from a superior system through a first communication line and a slave to which electric power is supplied from the master through a second communication line, the slave being to send a process variable as measured according to a software to the master through the second communication line, comprises:

storing version update data for the software in a first memory of the master; and

storing the software and a version of the software in a second memory of the master.

The master may compare version information of the software sent from the slave with version information of version upgrade data, and when there is no agreement in the version information, the slave may rewrite the software on a basis of the version upgrade data sent from the master.

The master may receive the version upgrade data from the superior system through the first communication line.

The master may output information about a progress of version upgrade to a display.

After the version upgrade, the master may collate storage content of the software in the second memory with the version upgrade data.

The software may be repaired when there is no agreement in a collation result.

The version upgrade data may have identification information on a slave-by-slave basis and update the software for the plurality of slaves according to the identification information.

As described above, according to the present invention, the version update data possessed in the memory of the master is transferred to the slave where the slave rewrites the memory of the slave. Due to this, the software can be subject to version upgrade without exchanging the slave hardware, thus achieving an intelligent transmitter that reduces the operator of risk and diminishes the cost required for maintenance of safety and exchange operation.

Other features and advantages may be apparent from the following detailed description, the accompanying drawings and the claims.

### BRIEF DESCRIPTION OF THE DRAWINGS

FIG. 1 is a configuration block diagram showing an embodiment of an intelligent transmitter according to the present invention.

FIG. 2 is a flow showing a version upgrade operation of the FIG. 1 apparatus.

FIG. 3 is an operation explanatory figure showing the concept of data in version upgrade.

FIG. 4 is a structural explanatory figure showing a first modification of the FIG. 1 intelligent transmitter.

FIG. 5 is a structural explanatory figure showing a second modification of the FIG. 1 intelligent transmitter.

FIG. 6 is a structural explanatory figure showing a third modification of the FIG. 1 intelligent transmitter.

FIG. 7 is a structural explanatory figure showing a fourth modification of the FIG. 1 intelligent transmitter.

FIG. 8 is an explanatory view showing an example of the related-art intelligent transmitter.

### DETAILED DESCRIPTION

With use of the drawings, explanation will be made in detail on the present invention.

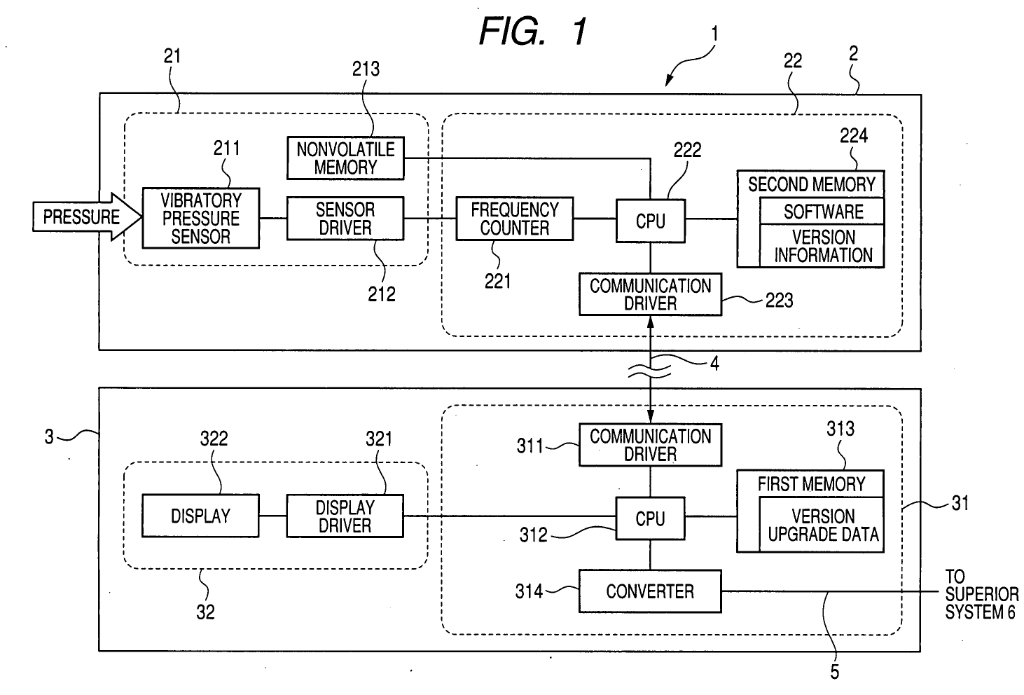

FIG. 1 is a configuration block diagram showing an embodiment of an intelligent transmitter according to the present invention.

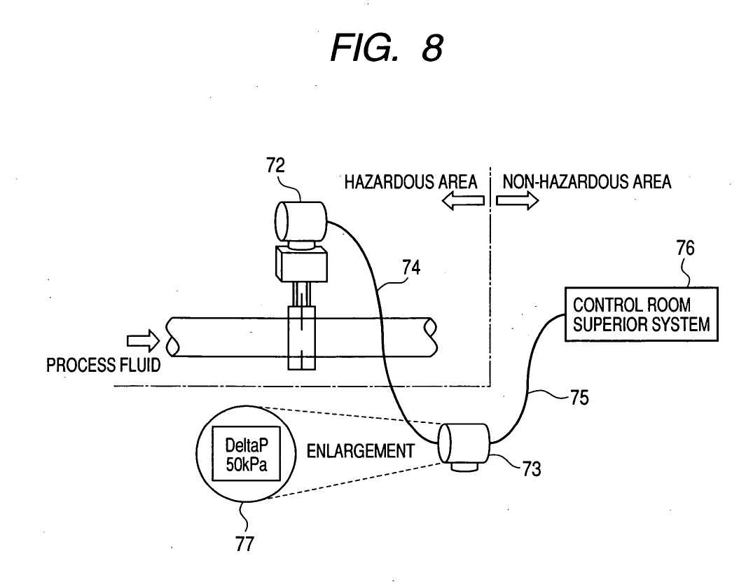

An intelligent transmitter 1 is constituted with a set of a slave 2 and a master 3 that are separated in individual cases, similarly to the related-art of FIG. 8. The slave 2 has a CPU and an amplifier (circuit board) mounting thereon the software for controlling the CPU. The master 3 has a CPU and an amplifier (circuit board) mounting thereon the software for controlling the CPU and version upgrade data for the software for controlling the CPU of the slave 2. The master 3 is of a bus-powered type connected to a superior system 6 through a two-wire loop 5 forming a first communication line so that it can communicate data with the superior system 6 and obtain the power for driving the intelligent transmitter 1 from the superior system 6. The slave 2 of a bus-powered type connected to the master 3 through a data bus 4 forming a second communication line so that it can communicate data with master 3 and obtain the power for driving the slave from the master 3. The slave 2 is to measure the pressure of process fluid by means of a sensor. The master 3 is to acquire through the data bus 4 a process variable to be displayed on a display and sent the process variable to the superior system 6 through the two-wire loop 5. In the slave 2, a sensor module 21 is to detect the pressure of process fluid. An amplifier module 22 is to convert the signal, detected by the sensor module 21, into digital data, perform arithmetic processing to the digital data, and perform the data communication with the master 3.

In the sensor module 21, a sensor driver 212 is to excite the vibrator in a vibratory pressure sensor 211 and extract and output, as an electric signal, the vibrator's vibration frequency changing with pressure. A nonvolatile memory 213 stores data for correcting the variations on the individual sensor. With the correction, the sensor module and the amplifier module are mutually kept independent so that the result is obtainable identical at all times even if the sensor module and the amplifier module are changed in arrangement.

In the amplifier module 22 (referred also to as a slave amplifier), a frequency counter 221, a second memory (referred also to as a slave memory, the first memory is referred later) and a communication driver 223 are connected to a CPU 222 through a CPU bus. The electric signal, outputted from the sensor driver 212, is counted at the frequency counter 221 and converted into frequency information, and then the CPU 222 performs the arithmetic processing to the frequency information to obtain pressure information. The memory 224 is a writable memory such as a flash ROM or an EPROM, storing the software for controlling the CPU 222 operation, e.g. correcting arithmetic processing using sensor-based data read out of the nonvolatile memory 213, together with the version information of the software.

In the master 3, an amplifier module 31 is to execute the software update process for the slave 2 in addition to data communication with the slave 2 and superior system 6 and transmission, display, etc. of the measurement data received from the slave 2. A display module 32 is to display the progress information about version upgrade in addition to displaying measurement process quantity, etc. based on the data sent from the amplifier module 31.

In the amplifier module 31 (referred also to as a master amplifier), a communication driver 311, a first memory 313 (referred also to as a master memory) and a converter 314 are connected to a CPU 312 through a CPU bus. The communication driver 311 is connected to the communication driver 223 through the data bus 4, to mutually exchange data. The converter 314 is to convert the digital data, outputted from the CPU 312, into a transmission signal having 4-20 mA and output it onto the two-wire loop 5. The memory 313 is a writable memory to store the software for controlling the CPU 312 and the version upgrade data for the software for the slave 2. Here, version upgrade data means data that required pieces of information for version upgrade are gathered, including information about the version as to the version upgrade data, software data, write address and size information of software data.

In the display module 32, a display driver 321 is to drive a display 322 formed by an LCD, etc. based on the display data outputted from the CPU 312 through the CPU bus, and display a measurement process quantity and the information about the progress of version upgrade.

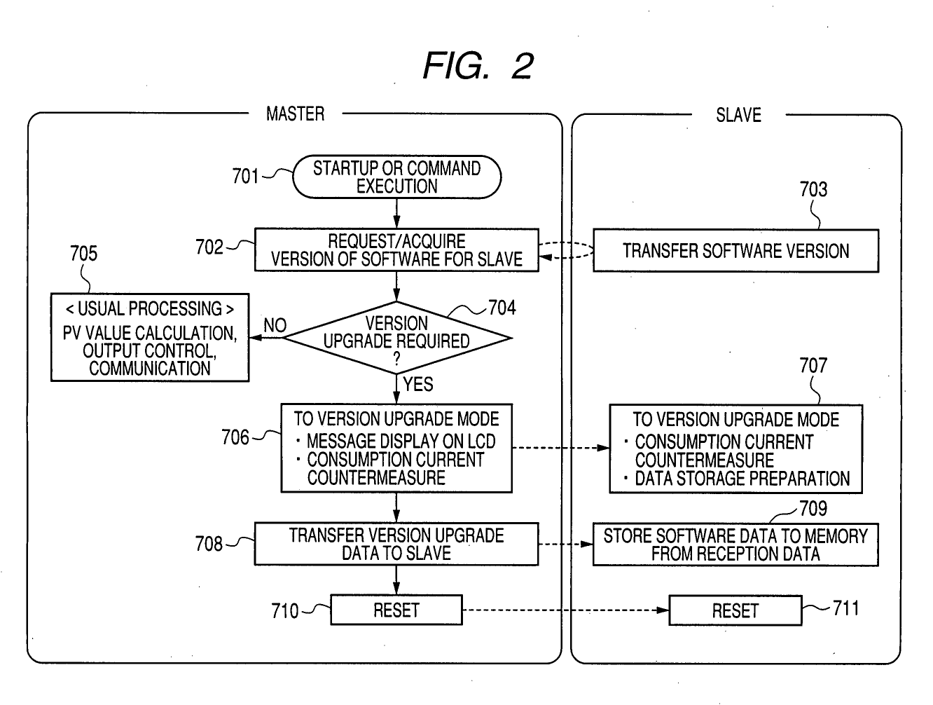

The version upgrade operation on the FIG. 1 apparatus is explained below by use of the flowchart of FIG. 2.

1) By starting up the master 3 or executing the command of from the superior system 6 (step 701), the master 3 requests the information about the version of software to the slave 2 (step 702).

2) The slave 2 transfers the version information to the master 3, by request of software version information from the master 3 (step 703)

3) The master 3 determines a necessity/non-necessity of version upgrade (step 704). In the case the version information acquired from the slave 2 and the version of the version upgrade data are not in agreement, version upgrade is determined necessary and the process transits to a version upgrade mode (step 706). If version is the same between the both, determination is made as unnecessary and the process is in the usual operation mode. The intelligent transmitter 1 makes measurement and output of a process variable (step 705).

4) Transition to version upgrade mode (step 706).

The master 3 requests the slave 2 to [transit to version upgrade mode], wherein it transits to version upgrade mode and displays the message thereof on the display 322. Here, the version upgrade mode is a mode for performing version upgrade. During version upgrade, there are cases requiring an electric current in a greater amount than the product rating because of rewriting the flash memory, etc. In this mode, the following measures a)-d) are taken on consumption current.
a) Supply current is increased by increasing output current. For example, for a 4-20 mA apparatus, supply current is determined by the magnitude of output current.
b) Consumption current is decreased by lowering CPU clock frequency, to utilize the reduced portion of current for rewriting the flash memory.
c) Consumption current is decreased by powering off the peripheral devices (functions) not required in version upgrade, to utilize the reduced portion of current for rewriting the flash memory.
d) Maximum consumption current is lowered by divisionally rewriting the flash memory, e.g. use the method disclosed in Japanese Patent Unexamined Publication No. 2005-227920.

5) The slave 2 transits to version upgrade mode (step 707) by request of [a transition to version upgrade mode]. Measure is taken for consumption current similarly to 4) and preparation is made for storing data.

6) The master 3 transfers version upgrade data from memory 313 to the slave 2 (step 708). This is repeated until all the version upgrade data has been transferred.

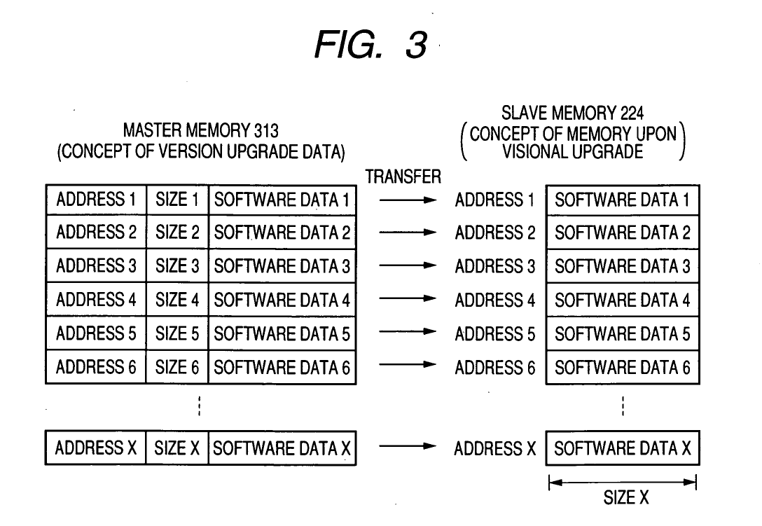

7) The slave 2 receives the version upgrade data from the master 3, to write software data in an amount of the data size of the relevant data in the memory area of the memory 224 corresponding to the address in the relevant data (step 709). FIG. 3 is an operation explanatory figure showing the data arrangement in that case.

8) The master 3 completes the version upgrade (step 710). The master 3 requests a CPU-reset to the slave 2 wherein the master 3 itself performs a CPU-reset.

9) The slave 2 executes the CPU-reset when requested (step 711).

After the CPU-reset, the slave 2 operates on the software whose version is upgraded.

In the below, shown is the main operation on the FIG. 1 apparatus according to the flow in FIG. 2.

Steps 703, 704 (acquisition and comparison of software-version information):

The software-version information for the slave 2, stored in the memory 224, is read out to the CPU 222 and sent to the communication driver 311 through the communication driver 223 and data bus 4 so that the CPU 312 compares it with the version information of the version upgrade data read out of the memory 313.

Step 705 (usual operation mode):

The frequency signal, outputted from the sensor driver 212, is converted by the frequency counter 221 into frequency information. In the CPU 222, the frequency information is subjected to correction arithmetic processing, etc. using the read-out data of the nonvolatile memory 213, according to the software stored in the memory 224 thus being changed into pressure information. The measurement pressure data is sent to the CPU 312 through the communication driver 223, the data bus 4 and the communication driver 311. The CPU 312 sends the measurement pressure data to the superior system 6 through the converter 314 and the two-wire loop 5, also outputting same as display data to the display module 32.

Steps 708, 709 (transfer and write of the version upgrade data to the memory 224):

The version upgrade data, in the memory 313, is read out by the CPU 312 and sent from the communication driver 311 to the communication driver 223 through the data bus 4 so that the CPU 222 can write it to the memory 224.

Meanwhile, progress data display and software update data download are performed as in the following.

Progress data display: Along with the progress of version upgrade operation based on the software stored in the memory 313, progress information data is outputted from the CPU 312 to the display driver 321.

Version upgrade data download: Version upgrade data is sent from the superior system 6 through the two-wire loop 5. After signal-converted at the converter 314, the data is stored in the memory 313 via the CPU 312.

According to the intelligent transmitter structured as above, by updating the version upgrade data possessed in the memory 313 of the master 3, the software for the slave 2 can be subject to version upgrade without exchanging the hardware of the slave 2. Accordingly, measurement result can be confirmed without going to the site not easy for the operator to access. As a result, the operator is reduced of risk, which can diminish the cost required for maintenance of safety and exchange operation.

Although the embodiment uses the vibratory pressure sensor in the sensor module, this is not limitative. Application is possible to other schemes of pressure sensors and various process-quantity sensor related to temperature, flow rate or the like.

In the embodiment, the version upgrade data, stored in the memory 313 of the master 3, was updated by way of the network by using domain download, etc. standardized under Foundation Fieldbus. Alternatively, it may be by hardware exchange, e.g. amplifier exchange.

Version upgrade includes not only an update to a new version but also a restoration to the older version.

The embodiment showed the case of rewriting the software on the slave memory 224. Alternatively, where there is an available space in the memory 224, write may be to another area. In this case, restoration is easy to the older version.

In the embodiment, in the master 3, the version upgrade data and the control software for CPU 312 were stored in the same memory 313. Alternatively, the version upgrade data may be stored in another memory. When updating the version upgrade data, exchanging the relevant memory lowers exchange cost.

In the embodiment, startup of the master 3 or executing the command from the superior system 6 was applied as a trigger to start the version upgrade. By providing the apparatus with the following setting information, the trigger may be provided selective in starting a version upgrade.

1) Starting a version upgrade at a startup

2) Starting a version upgrade according to a command (communication) from the superior system

3) Starting a version upgrade at a time designated

The version upgrade progress information may be displayed in the form of %, bar graph, under data collation, data collation completed, collation error occurring, under data repair or the like, on the display of the master 3, and be outputted to the superior system 6 through the two-wire loop 5.

Meanwhile, function for rejecting version upgrade may be provided. Version upgrade may be applied also to hardware besides to software. In this case, the software for new hardware problematically does not operate on the older hardware. In order to avoid this, there is a need to reject a version upgrade not to be supported by the relevant hardware. For example, hardware versions are allocated respectively to the master and slave, the pieces of information are provided to the respective memories so that version upgrade data can be provided with the version information about the corresponding hardware. As a result, in version upgrade, the hardware version according to the version upgrade data is compared with the hardware version of the apparatus. When not applicable, version upgrade can be rejected.

Version upgrade data can take various forms of data structure. For example, if data size is previously fixed, structure can be only with address and data. If write-destination address is previously determined, structure may be only with version upgrade data and size.

Version upgrade type can be selected in various ways. For example, partial write (partial rewrite of software in a manner applying a patch) or thorough rewrite (providing a plurality of software storage areas, to switch over the area after version upgrade) can be performed as a rewrite operation to the memory 224 of the slave.

Although the embodiment and modification shows the two-wire transmitter using a two-wire loop in connection to the superior system, a three-wire or four-wire transmitter can be applied that is used in the field of process automation.

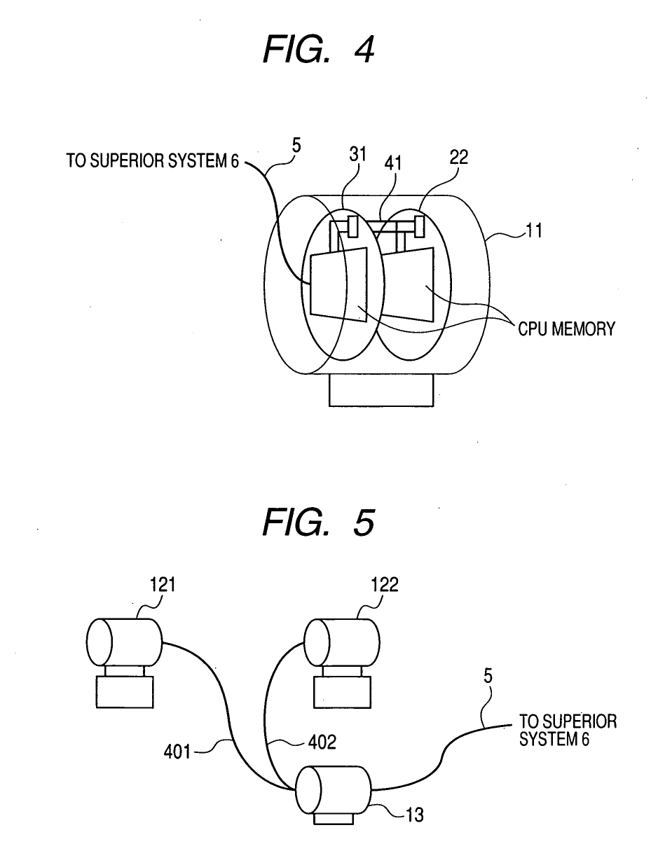

FIG. 4 is a modification of the FIG. 1 intelligent transmitter, explaining a structure illustrating the more general transmitter form. Within a transmitter case 11, a master amplifier 31 and a slave amplifier 22 are arranged wherein the both are connected by a connector 41 to thereby form a data bus 4. The master amplifier 31 is connected to a superior system 6 through a two-wire loop 5.

As shown in the FIG. 4 structure, even for the general transmitter form, the present invention is to be applied provided having a master/slave internal structure. In this case, because only one case is required while no cable is needed in structuring the data bus 4, noise can be reduced in a detection signal while cost can be lowered.

FIG. 5 is a second modification of the FIG. 1 intelligent transmitter, explaining a structure showing a case having a plurality of slaves 2. A first slave 121 and a second slave 122 are connected to a master 13 through respective data bus cables 401, 402. The master 13 is connected to a superior system 6 through a two-wire loop 5. In this case, version upgrade data is provided with respective pieces of identification information for slave 121 and slave 122 so that software can be updated according to the foregoing procedure.

According to the intelligent transmitter structured as in FIG. 5, one master can be shared between a plurality of slaves where detecting a multiplicity of variables, thus enabling cost reduction.

Although the above modification showed the case with two slaves, application is possible to a case with those three or more in a desirable plural number.

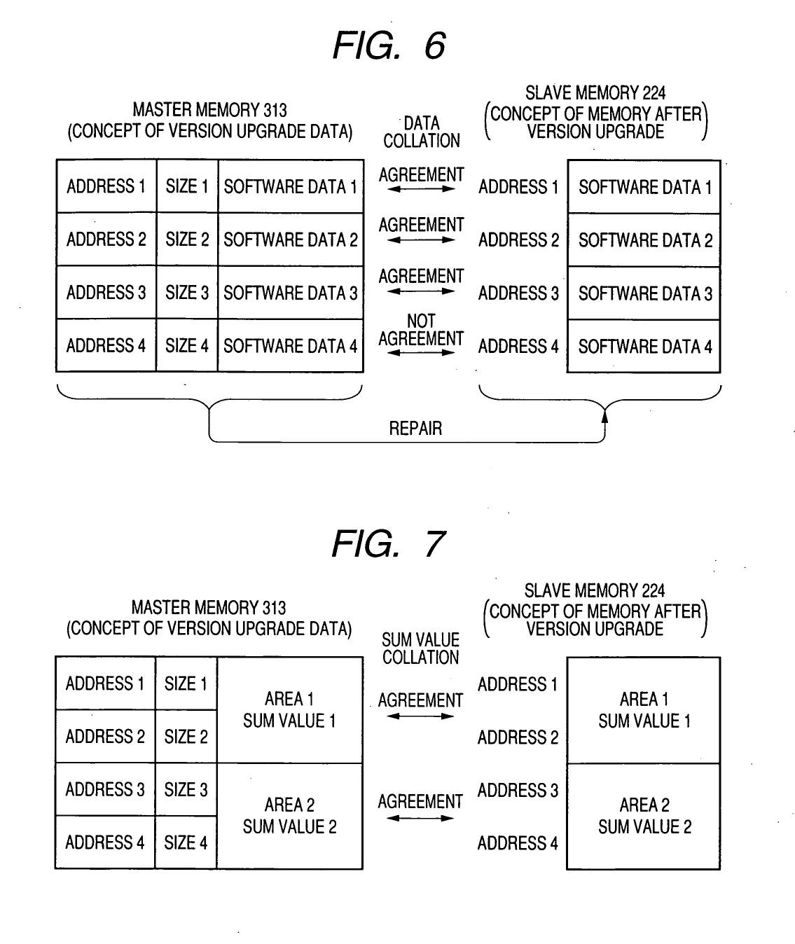

FIG. 6 is a third modification of the FIG. 1 intelligent transmitter, explaining an operation showing a confirmation of a successful version upgrade and a repair in a failure. In order to confirm a successful version upgrade, software data is collated at between the master 3 and the slave 2. Confirmation is made on an agreement between the version upgrade data in the master 3 and the storage content (address, size, data) in the memory 224 of the slave 2. In the case of not agreement as in the address (4) of the FIG. 6 slave memory, data repair is tried again by transferring version upgrade data from the master to the slave. After repair, collation is again made from the beginning, which is repeated until reaching a perfect agreement. When the non-agreement is not eliminated even by repeating it several times, version upgrade can be considered as a failure thus raising a status in the transmitter. The above operation can be realized, in the FIG. 1 apparatus, by transferring data in the memory 224 corresponding to the addresses of version upgrade data to the master 3 side and comparing, in the CPU 312, the size and data with those of the version upgrade data.

FIG. 7 is an operation explanatory figure showing a fourth modification of the FIG. 1 intelligent transmitter. Although collation was on all the data in FIG. 6, area may be divided with suitable blocks as shown in FIG. 7 so that collation can be made between the SUM values of the areas. Here, SUM value is the total sum of software data over the areas, utilizing the fact that, if there is an error in the software data, disparity arises in the total sum. As a result, processing can be at high speed because of reduced transfer data. In this case, in the FIG. 1 apparatus, data may be summed up over predetermined areas by the slave-side CPU 222 and then transferred to the master side so that comparison can be made by the master-side CPU 312.

What is claimed is:

1. An intelligent transmitter comprising:
a master to which electric power is supplied from a superior system through a first communication line; and
a slave to which electric power is supplied from the master through a second communication line, the slave being to send a process variable as measured according to a software to the master through the second communication line,
wherein the master includes a first memory for storing version upgrade data for the software, and
the slave includes a second memory for storing the software and a version of the software.

2. An intelligent transmitter according to claim 1, wherein the master compares version information about the software sent from the slave with version information of the version upgrade data, and
when there is no agreement in the version information, the slave rewrites the software stored in the second memory on a basis of the version upgrade data sent from the master.

3. An intelligent transmitter according to claim 1, wherein the master receives the version upgrade data from the superior system through the first communication line.

4. An intelligent transmitter according to claim 1, wherein the master includes a display for displaying information about a progress of version upgrade.

5. An intelligent transmitter according to claim 1, wherein after a version upgrade, the master collates storage content of the software in the second memory with the version upgrade data.

6. An intelligent transmitter according to claim 5, wherein the software is repaired when there is no agreement in a collation result.

7. An intelligent transmitter according to claim 1, further comprising:
a connector for connecting the master and the slave; and
a transmitter case for accommodating the master and the slave.

8. An intelligent transmitter according to claim 1,
wherein the slave is in plurality and the second communication line is in plurality so that the plurality of slaves can be connected to the master, and
wherein the version upgrade data has identification information on a slave-by-slave basis and updates the software for the slaves according to the identification information.

9. A software update method for an intelligent transmitter having a master to which electric power is supplied from a superior system through a first communication line and a slave to which electric power is supplied from the master through a second communication line, the master having a first memory, the slave having a second memory, the slave being to send a process variable as measured according to a software to the master through the second communication line, the software update method comprising:
storing version update data for the software in the first memory of the master; and
storing the software and a version of the software in the second memory of the slave.

10. A software update method according to claim 9, further comprising:
comparing version information of the software of the slave with version information of the version upgrade data of the master; and
when there is no agreement in the version information in the comparing step, rewriting the software in the slave on a basis of the version upgrade data of the master.

11. A software update method according to claim 9, further comprising:
receiving the version upgrade data from the superior system through the first communication line,
wherein the received version upgrade data is stored in the first memory of the master.

12. A software update method according to claim 9, further comprising:
displaying information about a progress of version upgrade in a display.

13. A software update method according to claim 9, further comprising:
after a version upgrade, collating storage content of the software in the second memory with the version upgrade data of the master.

14. A software update method according to claim 13, further comprising:
repairing the software when there is no agreement in a collation result in the collating step.

15. A software update method according to claim 9, wherein the version upgrade data has identification information on a slave-by-slave basis and the software for a plurality of slaves is updated according to the identification information.
